(19) United States
(12) Patent Application Publication
(10) Pub. No.: US 2007/0254234 A1
(43) Pub. Date: Nov. 1, 2007

(54) Stabilized azo dye and method for its preparation

(75) Inventor: Scott Zavada, Wixom, MI (US)

Correspondence Address: GIFFORD, KRASS, SPRINKLE,ANDERSON & CITKOWSKI, P.C, PO BOX 7021, TROY, MI, 48007-7021, US

(73) Assignee: Precision Coatings, Inc., Walled Lake, MI (US)

(21) Appl. No.: 11/411,488

(22) Filed: Apr. 26, 2006

(51) Int. Cl. G03C 5/18; C09B 45/00

(52) U.S. Cl. 430/141; 534/692; 534/726

(57) ABSTRACT

A diazo dye is stabilized through reaction with a metallo-alkoxide compound of the formula:
M-(OR)ₙ
wherein n is an integer from 2 to 6 inclusive; R in each occurrence is a C₁-C₆ hydrocarbon; and M is a transition metal, main group metal or silicon. The stabilized dye exhibits an inhibited migration in graphic arts applications and as a coloring agent.

### FIELD OF THE INVENTION

This invention relates generally to dyes. More specifically, the invention relates to azo dyes which have been reacted with a specific class of reagent so as to produce a stabilized dye which is less prone to migrate when incorporated into various compositions.

### BACKGROUND OF THE INVENTION

Azo dyes are formed by the reaction of a diazonium salt with a coupling agent. For that reason azo dyes are also, somewhat incorrectly, referred to as diazo dyes. Azo dyes are widely used in a number of graphic arts applications, and as coloring agents for a variety of products including polymers, textiles and the like. Problems caused by azo dye migration limit and/or complicate the use of azo dyes in many applications. Dye migration can result in colors fading or bleeding, and in graphic arts applications, migrating dyes can contaminate adjacent layers of material thereby compromising their function. In many graphic arts applications, it is necessary to include barrier layer structures to prevent azo dye migration. Clearly, there is a need for materials and methods which can prevent such dye migration. Furthermore, any such materials and methods must not affect the optical properties of the azo dye.

### SUMMARY OF THE INVENTION

A stabilized azo dye material is formed as the reaction product of an azo dye with a metallo-alkoxide compound. The metallo-alkoxide compound has the formula:
M-(OR)ₙ
wherein n is an integer from 2 to 6 inclusive; R in each occurrence is a hydrocarbon such as a C₁-C₁₀ hydrocarbon, although longer chain materials will have particular advantages in some instances. M is a transition metal, main group metal or silicon. Preferably, a coupling agent is reacted with a diazonium salt to form the azo dye. While broad classes of coupling agents are operative, aromatic alcohols and ethers having strong ultraviolet light absorption relative to visible light absorption are particularly preferred.

A method of stabilizing an azo dye includes reacting the azo dye with a metallo-alkoxide compound having the formula:
M-(OR)ₙ
wherein n is an integer from 2 to 6 inclusive; R in each occurrence is a hydrocarbon as noted above; and M is a transition metal, main group metal or silicon. The resulting azo dye is reacted in a nonaqueous environment and subsequently hydrolyzed to yield a stabilized azo dye precipitate. The resulting precipitate is thereafter solubilized for subsequent usage. The reactant azo dye is preferably formed by the reaction of a diazonium salt with a coupling agent.

### DESCRIPTION OF THE INVENTION

The present invention is directed to stabilized azo dye materials. According to the methodology of the present invention, azo dyes are reacted with organometallic or organosilicon compounds to produce a reaction product which preserves the optical properties of the diazo dye while inhibiting dye migration.

The preferred reagent for the practice of the present invention is a metallo-alkoxide of the general formula M-(OR)ₙ where n is an integer from 2 to 6 inclusive, and R in each occurrence is independently a hydrocarbon. The hydrocarbon chain in some instances is a C₁-C₁₀ chain; but, longer chain materials including aromatic materials may be employed in the present invention. M is a main group or transition metal or silicon ion. As is understood in the art, the term “hydrocarbons” as used herein includes substituted or unsubstituted alkanes, alkenes, alkynes and aromatics. When M is a metal, it is most preferably a group IVA or IVB metal, with titanium and zirconium being some specifically preferred metals.

The R groups are, in one particularly preferred embodiment, are alkanes, and C₄ alkanes are particularly preferred. More preferably, all instances of R are identical groups. One specifically preferred material comprises tetrabutyl titanate. Tetrapropyl titanate is another preferred material. Inventive reagents are appreciated to include C₅ or C₆ alkanes as R₀ groups with longer chain R groups likewise employed with the appreciation that the reaction rate of an inventive reagent decreases as the carbon content of the reagent increases.

In the context of the present invention, the stabilized azo dye material is described as being a reaction product of an azo dye and the aforedescribed reagent, and it is to be understood that this description encompasses covalently bound reaction products as well as ionically bound reaction products, adducts, chelates, complexes, coordination compounds, and the like.

In general, the stabilized dye of the present invention is prepared by reacting an azo dye with the above-described reagent. The reagent is prone to hydrolysis; hence, the reaction is initially carried out in a nonaqueous solvent. Dry acetone is one particularly preferred solvent. Reaction kinetics depend upon the nature of the R groups; however, most reactions in accord with the present invention proceed at room temperature within one to five hours. In a second stage of the reaction, one or more of the OR groups of the reagent are hydrolyzed by the addition of water, either by itself or with a co-solvent such as an alcohol, to the reaction mixture. This generally produces a precipitate of the dye complex. This precipitate is washed and dried.

It has been found that the resultant precipitate from this reaction is readily soluble in a variety of solvents typically employed in the preparation of azo dye containing products. These solvents illustratively include N-methyl pyrrolidone, acetone, benzyl alcohol, 1,3-dioxolane, tetrahydrofuran, dimethylformamide and dimethylacetamide. The stabilized dye of the present invention has significant utility in graphic arts materials, such as materials used for the preparation of photo tools, photo masks and the like, since it is compatible with the polymers and solvents used in the preparation of such materials, and since it does not migrate under conditions of storage and use.

The present invention is not limited to any specific azo dye. One class of azo dyes which have significant utility in various graphic arts applications are formed by reacting a diazonium salt having the structure of Formula 1 or Formula 2 below, with a coupler: 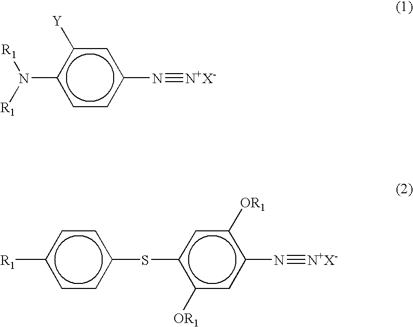
In these salts, R₁ in each occurrence is independently hydrogen or a C₁-C₁₆ alkyl; Y is a halogen, F, Cl, Br or I; and X is an anion.

An inventive diazo salt is preferably reacted with N—(OR)n by way of a coupling reagent therewith. One class of coupling agents includes: aromatic coupling agents that produce resulting azo dyes with strong ultraviolet radiation absorption and comparative transparency to visible light wavelengths. Some preferred aromatic coupling agents are shown in Formulas 3 and 4 below: 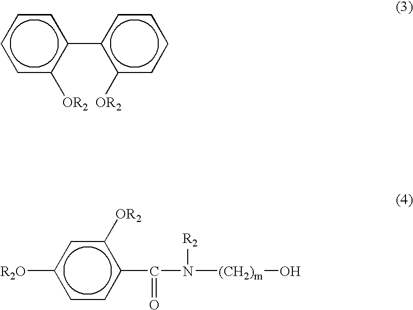
In these coupling agents, R₂ is independently hydrogen or a C₁-C₁₆ alkyl; and m is 0 or a positive integer. Preferably m is less than 13.

An inventive azo dye is readily formed according to the present invention through a variety of reaction ratios between a metallo-alkoxide: diazo salt: coupling agent on a mole basis of 1:0.16-6:0.04-6. It is appreciated that an inventive stabilized azo dye, depending on the reagent ratio, is present as a molecular species or an oligomeric species limited only in molecular weight by the requirement that the inventive dye precipitate be capable of solubilization in an aforementioned solvent. In a particular preferred embodiment, the molar ratio between metallo-alkoxide: diazo salt: coupling agent is 1:1:1 so as to yield a highly colored and soluble dye. In other instances, it is appreciated that satisfactory image intensity is achieved with a metallo-alkoxide: diazo salt ratio of 1:0.16-0.5 thereby more efficiently utilizing azo dye. Additionally, it is appreciated that the coupling agent be optionally reacted with a metallo-alkoxide, and the resulting product in turn reacted with a diazonium salt to yield an inventive stabilized diazo dye material.

The following examples are illustrative of the present invention:

### EXAMPLE 1

A stabilized azo dye material was prepared according to the following procedure. In a first step, 32.7 grams of tetra n-butyl titanate (Tyzor® TBT obtained from the Du Pont Chemical Company) was mixed in a 400 ml beaker with 20 grams of acetone. Mixing was carried out for 5 minutes using a magnetic stirrer. 40 grams of a azo dye, formed by the reaction of the diazonium salt of Formula 1 above where R₁ is ethyl in each occurrence, Y is chlorine and X⁻ is PF₆⁻, with the coupling agent of Formula 3 above where R₂ in each occurrence is H was dissolved in 80 grams of acetone, and added dropwise to the titanate solution, with stirring, over a 15 minute period. This resulted in a clear solution. The resultant solution was stirred for 1½ hours at room temperature, and no precipitate was observed. Thereafter, a solution of 120 grams of water and 45 grams of methanol was added, quickly, to the stirred solution. This resulted in the immediate formation of a precipitate. The resultant mixture was hand stirred for 5 minutes to break up the precipitate, and thereafter the magnetic stirrer was used to stir the mixture for ½ hour. Following stirring, the reaction mixture was covered and allowed to stand overnight, after which the precipitate was filtered out and washed with about 50 grams of acetone. The precipitate was air dried, and the reaction produced 30.6 grams of dried powder.

### EXAMPLE 2

In another preparation, 40 grams of the aforedescribed azo dye and 80 grams of acetone were stirred in a 400 ml beaker at room temperature, using a magnetic stirrer. Mixing was carried out for 10 minutes. Thereafter, 21.8 grams of tetrabutyl titanate was added to the beaker in a dropwise manner over a 15 minute period. Stirring was continued for 2 hours, and no precipitate formation was observed. Thereafter, a solution of 120 grams water and 45 grams of methanol was added to the mixture in a dropwise manner over ½ hour. Formation of a precipitate commenced immediately upon the initial addition of the water/methanol solution. Mixing was carried out for one hour following the addition of the water and methanol, and the resultant solution was covered and allowed to stand overnight. Thereafter, the precipitate was filtered, washed with 50 grams of acetone, and air dried. The reaction produced 26.2 grams of dried powder.

While not wishing to be bound by theory, Applicant presumes that the azo dye has reacted with one or more of the OR groups of the reagent in the first stage of the reaction, and upon addition of the water/methanol mixture, any unreacted OR groups are hydrolyzed to OH. The resultant product manifests the optical absorption properties of the diazo dye. It is soluble in N-methyl pyrrolidone, which is commonly employed for the preparation of azo dye containing materials. It is notable that the products of the aforedescribed syntheses, unlike the parent dyes, do not migrate when incorporated into polymeric matrices. While not wishing to be bound by theory, Applicant presumes that the product of the present invention binds to or otherwise interacts with the polymeric matrix to prevent dye migration.

### EXAMPLE 3

The procedure of Example 1 is repeated with the substitution of a stoichiometrically equivalent amount of operative precipitate for tetrabutyl titanate resulting in a product according to the present invention.

### EXAMPLE 4

The procedure of Example 1 is repeated with the substitution of a stoichiometrically equivalent amount of hexamethyl diisocyanate for the coupling agent resulting in a product according to the present invention.

In further experimental series, tetrapropyl titanate (Tyzor® TPT) has been employed to produce the stabilized azo dyes. Applicant speculates that other similar materials having other hydrocarbons attached thereto may be likewise employed. Also, chelates or other complexes of the reagent such as chelated organotitanates may be employed in the practice of the present invention. Organozirconium or organosilicone reagents will also give similar results.

The foregoing discussion, description and examples are illustrative of specific embodiments of the present invention but are not meant to be limitations upon the practice thereof. It is the following claims, including all equivalents, which define the scope of the invention.

1. A stabilized azo dye material comprising: the reaction product of an azo dye and a metallo-alkoxide compound of the formula:
M-(OR)ₙ
wherein n is an integer from 2 to 6 inclusive; R in each occurrence is a hydrocarbon; and M is a transition metal, main group metal or silicon.

2. The stabilized azo dye material of claim 1 wherein M is a periodic table Group IVA or Group IVB metal.

3. The stabilized azo dye material of claim 1 wherein M is titanium.

4. The stabilized azo dye material of claim 1 wherein M is zirconium.

5. The stabilized azo dye material of claim 1 wherein n is 4.

6. The stabilized azo dye material of claim 1 wherein R in all occurrences is the identical group.

7. The stabilized azo dye material of claim 1 wherein R in all occurrences is an alkyl group.

8. The stabilized azo dye material of claim 4, wherein all R groups are butyl.

9. The stabilized azo dye of claim 1 wherein said azo dye is the reaction product of a coupling agent and a diazonium salt.

10. The stabilized azo dye material of claim 9 wherein said coupling agent is one or more of an aromatic alcohol, an aromatic ether, or an aromatic ester.

11. The stabilized azo dye material of claim 9 wherein a molar ratio between said metallo-alkoxide: said diazonium salt: said coupling agent is 1:016-6:0.004-6.

12. The stabilized azo dye material of claim 11 wherein said molar ratio is 1:09-1.1:0.9-1.1.

13. The stabilized azo dye material of claim 1, wherein said diazo dye is the reaction product of an aromatic coupling agent with a diazonium salt selected from the group consisting of: 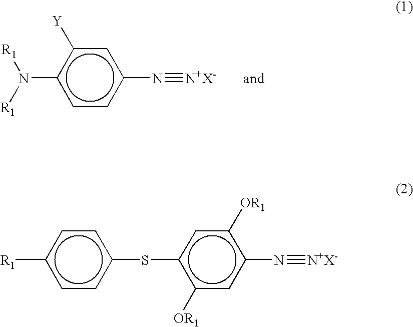
wherein R₁ is independently in each occurrence hydrogen or a C₁-C₁₆ alkyl, Y is a halogen and X is an anion.

14. A stabilized azo dye material as in claim 9, wherein said coupling agent is selected from the group consisting of: 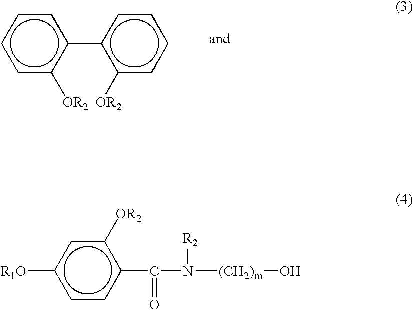
wherein R₂ is independently in each occurrence hydrogen or a C₁-C₁₆ alkyl and m is 0 or a positive integer.

15. A method of stabilizing an azo dye comprising the step of: reacting said azo dye with a metallo-alkoxide compound having the formula:
M-(OR)ₙ
wherein n is an integer from 2 to 6 inclusive, R in each occurrence is a hydrocarbon, and M is a transition metal, main group metal or silicon, so as to yield a product.

16. The method of claim 15 wherein M is a periodic table Group IVA or IVB metal.

17. The method of claim 15 further comprising the step of: hydrolyzing said product to yield a precipitate.

18. The method of claim 17 further comprising the step of: solubilizing said precipitate.

19. The method of claim 18 wherein solubilization occurs in a solvent selected from the group consisting of one or more of: N-methyl pyrrolidone, acetone, benzyl alcohol, 1,3-dioxolane, tetrahydrofuran, dimethylformamide and dimethylacetamide.

20. The method of claim 18 wherein solubilization occurs in N-methyl pyrrolidone.

21. The method of claim 15 wherein said azo dye is the reaction product of a coupling agent and a diazonium salt.

22. The method of claim 21 wherein said coupling agent is one or more of an aromatic alcohol, an aromatic ether, or an aromatic ester.

23. The method of claim 21 wherein a molar ratio between said metallo-alkoxide: said diazonium salt: said coupling agent is 1:016-6:0.004-6.

24. The method of claim 23 wherein said molar ratio is 1:09-1.1:0.9-1.1.

25. The method of claim 15 wherein M is titanium.

26. The method of claim 15 wherein M is zirconium.

27. The method of claim 15 wherein n is 4.

28. The method of claim 15 wherein said metallo-alkoxide compound is tetrabutyl titanate.

29. The method of claim 21 wherein said azo dye is the reaction product of said coupling agent with a diazonium salt selected from the group consisting of: 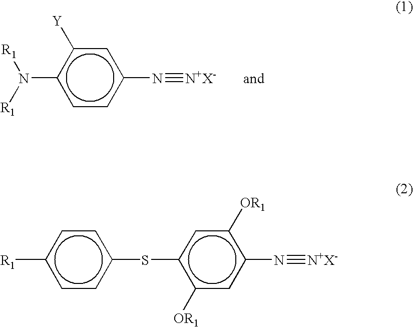
wherein R₁ is independently in each occurrence hydrogen or a C₁-C₁₆ alkyl, Y is a halogen and X is an anion.

30. The method of claim 21 wherein said coupling agent is selected from the group consisting of: 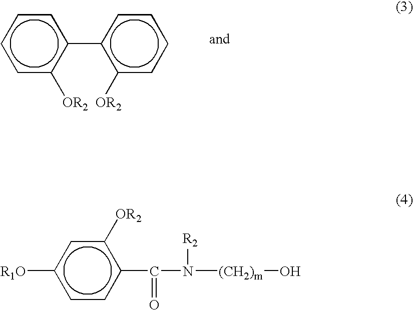
wherein R₂ is independently in each occurrence hydrogen or a C₁-C₁₆ alkyl and m is 0 or a positive integer.

31. A photosensitive member comprising a stabilized azo dye according to claim 1.
